(19) United States
(12) Patent Application Publication
(10) Pub. No.: US 2026/0368013 A1
(43) Pub. Date: Nov. 19, 2026

(54) INFORMATION PROCESSING APPARATUS AND CONTROL METHOD FOR INFORMATION PROCESSING APPARATUS

(71) Applicant: Lenovo Japan LLC, Tokyo (JP)

(72) Inventors: Tingting Zhang, Kanagawa (JP); Takashi Sugawara, Kanagawa (JP); Yusuke Taira, Kanagawa (JP)

(73) Assignee: Lenovo Japan LLC, Tokyo (JP)

(21) Appl. No.: 19/640,209

(22) Filed: Apr. 6, 2026

(30) Foreign Application Priority Data
May 14, 2025 (JP) 2025-081103

(51) Int. Cl. G06F 11/07

(52) U.S. Cl. CPC G06F 11/0727

(57) ABSTRACT

An information processing apparatus connectable to a storage device is provided. The information processing apparatus includes a controller configured to output, to the storage device, an instruction to store data stored in a volatile memory of the storage device into a non-volatile memory of the storage device, when an abnormality is detected after an operating system (OS) of the information processing apparatus starts communication with the storage device.

### CROSS-REFERENCE TO RELATED APPLICATIONS

This application claims priority to Japanese Patent Application No. 2025-081103 filed on May 14, 2025, the contents of which are hereby incorporated herein by reference in their entirety.

### TECHNICAL FIELD

The present invention relates to an information processing apparatus and a control method for an information processing apparatus.

### BACKGROUND

In recent years, information processing apparatuses such as personal computers (PCs) equipped with solid state drives (SSDs) have become widespread. When an SSD communicates with an operating system (OS), data related to the communication (logs and cache data) is stored in a temporary memory in the SSD.

The OS or an application operating in the information processing apparatus may hang up. It may be possible to identify the cause of the hang-up by analyzing logs indicating, for example, the details of communication executed between the information processing apparatus and the SSD.

Japanese Unexamined Patent Application Publication No. 2024-117265 discloses an information processing apparatus including a processor in a main chipset and a sub-processor in a sub-chipset. When an abnormality occurs in the operation of the sub-processor, the output destination of log information indicating the operating status of the sub-processor is switched from an RAM in the sub-chipset to a log management memory in a log management chipset. When an abnormality occurs in the operation of the processor in the main chipset, log information stored in the RAM in the sub-chipset is stored in an ROM in the sub-chipset.

When the OS or an application hangs up, it may be possible to identify the cause of the hang-up by analyzing logs stored in a temporary memory in the SSD. However, when a user restarts the system to restore the system, the logs stored in the temporary memory in the SSD are erased.

### SUMMARY

One or more embodiments of the present invention provides an information processing apparatus and a control method for an information processing apparatus that are capable of saving data stored in a memory of a storage device.

One aspect of the present invention is an information processing apparatus connectable to a storage device, the information processing apparatus including a controller configured to output, to the storage device, an instruction to store data stored in a volatile memory of the storage device into a non-volatile memory of the storage device, when an abnormality is detected after an operating system (OS) of the information processing apparatus starts communication with the storage device.

Another aspect of the present invention is an information processing apparatus connectable to a storage device, the information processing apparatus including a controller configured to output, to the storage device, an instruction to prohibit overwriting of data in a non-volatile memory of the storage device, when an abnormality is detected after an operating system (OS) of the information processing apparatus starts communication with the storage device and storing of the data in the non-volatile memory is started.

In one or more embodiments, the controller may be configured to output the instruction to the storage device when an abnormality of the OS is detected.

In one or more embodiments, the controller may be configured to receive a heartbeat output by the OS while the OS is operating normally, and output the instruction to the storage device when the OS stops outputting the heartbeat.

In one or more embodiments, the controller may be configured to output the instruction to the storage device upon receiving an abnormality signal output when the OS detects an abnormality of an application of the information processing apparatus.

In one or more embodiments, the controller may be configured to output the instruction to the storage device when an abnormality of the storage device is detected.

In one or more embodiments, the controller may be configured to receive a heartbeat output by the storage device while the storage device is operating normally, and output the instruction to the storage device when the storage device stops outputting the heartbeat.

In one or more embodiments, the controller may be configured to reset the storage device after outputting the instruction to the storage device.

Yet another aspect of the present invention is a control method for an information processing apparatus connectable to a storage device, the control method including outputting, to the storage device, an instruction to store data stored in a volatile memory of the storage device into a non-volatile memory of the storage device, when an abnormality is detected after an operating system (OS) of the information processing apparatus starts communication with the storage device.

Yet another aspect of the present invention is a control method for an information processing apparatus connectable to a storage device, the control method including outputting, to the storage device, an instruction to prohibit overwriting of data in a non-volatile memory of the storage, when an abnormality is detected after an operating system (OS) of the information processing apparatus starts communication with the storage device and storing of the data in the non-volatile memory is started.

The above-described aspects of the present invention are capable of saving data stored in a memory of a storage device.

### BRIEF DESCRIPTION OF THE DRAWINGS

FIG. 1 is a diagram illustrating an example of the main hardware configuration of a laptop PC according to a first embodiment.

FIG. 2 is a functional block diagram illustrating an example of the functional configuration of the laptop PC according to the first embodiment.

FIG. 3 is a flowchart illustrating an example of operation of an embedded controller in the laptop PC according to the first embodiment.

FIG. 4 is a flowchart illustrating an example of operation of the embedded controller in the laptop PC according to the first embodiment.

FIG. 5 is a flowchart illustrating an example of operation of the embedded controller in the laptop PC according to the first embodiment.

FIG. 6 is a flowchart illustrating an example of operation of an embedded controller in a laptop PC according to a second embodiment.

FIG. 7 is a flowchart illustrating an example of operation of the embedded controller in the laptop PC according to the second embodiment.

FIG. 8 is a flowchart illustrating an example of operation of the embedded controller in the laptop PC according to the second embodiment.

### DETAILED DESCRIPTION

Embodiments of the present invention will be described below with reference to the drawings.

### First Embodiment

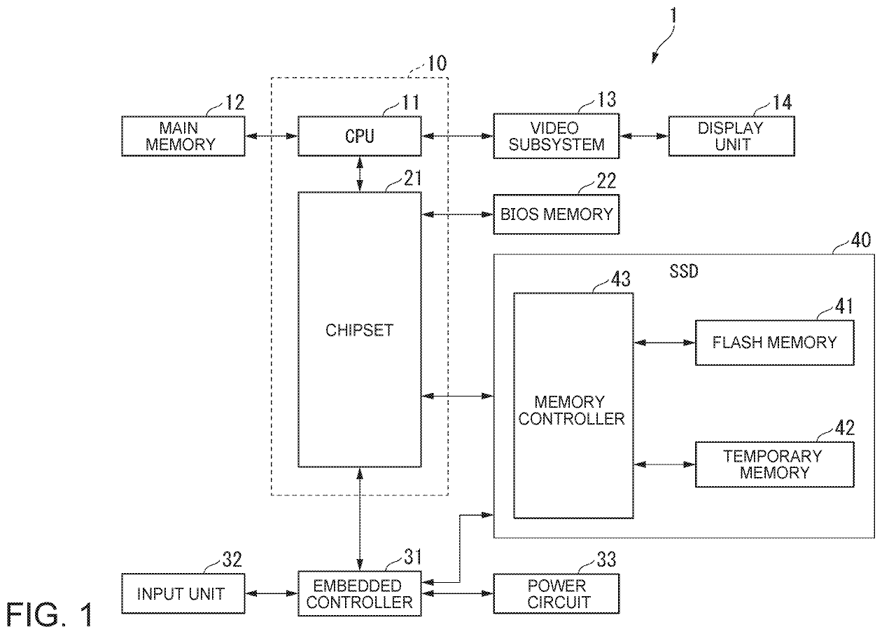

FIG. 1 is a diagram illustrating an example of the main hardware configuration of a laptop personal computer (PC) 1 according to a first embodiment.

As illustrated in FIG. 1, the laptop PC 1 includes a central processing unit (CPU) 11, a main memory 12, a video subsystem 13, a display unit 14, a chipset 21, a Basic Input/Output System (BIOS) memory 22, an embedded controller 31, an input unit 32, a power circuit 33, and a solid state drive (SSD) 40. In this embodiment, the laptop PC 1 will be described as an example of an information processing apparatus.

The CPU 11 performs various arithmetic processing by program control, and controls the overall laptop PC 1.

The main memory 12 is a writable memory used as an area for reading execution programs of the CPU 11 or a work area for writing processed data of the execution programs. For example, the main memory 12 is composed of a plurality of dynamic random access memory (DRAM) chips. The execution programs include an operating system (OS), various drivers for operating hardware of peripherals, various services/utilities, application programs, and the like.

The video subsystem 13 is a subsystem for implementing functions related to image display, and includes a video controller. The video controller processes drawing instructions from the CPU 11, and writes the processed drawing information to a video memory. The video controller also reads the drawing information from the video memory, and outputs the drawing information to the display unit 14 as drawing data (display data).

The display unit 14 is, for example, a liquid crystal display, and displays a display screen based on the drawing data (display data) output from the video subsystem 13.

The chipset 21 includes controllers for Universal Serial Bus (USB), Serial AT Attachment (ATA), Serial Peripheral Interface (SPI) bus, Peripheral Component Interconnect (PCI) bus, PCI-Express bus (PCIe bus), Low Pin Count (LPC) bus, and the like, and is connected to a plurality of devices. In FIG. 1, the BIOS memory 22 and the SSD 40 are connected to the chipset 21 as examples of devices.

In this embodiment, the CPU 11 and the chipset 21 correspond to a main control unit 10.

The BIOS memory 22 is, for example, composed of an electrically rewritable non-volatile memory such as an electrically erasable programmable read only memory (EEPROM) or flash ROM (flash memory). The BIOS memory 22 stores the BIOS, system firmware for controlling the embedded controller 31, etc., and the like.

The embedded controller 31 is a one-chip microcomputer that monitors and controls various devices (peripherals, sensors, etc.) regardless of the system state of the laptop PC 1. The embedded controller 31 also has a power management function of controlling the power circuit 33. For example, the embedded controller 31 includes a CPU, a ROM, and a RAM (not illustrated), and also includes A/D input terminals, D/A output terminals, timers, and digital input and output terminals of a plurality of channels. The embedded controller 31 is connected to the input unit 32, the power circuit 33, and the like via these input and output terminals, and controls their operations.

The input unit 32 is, for example, an input device such as a keyboard or a pointing device such as a touchpad.

The power circuit 33 includes, for example, a DC/DC converter, a charge/discharge unit, and an AC/DC adapter, and converts, for example, a DC voltage supplied from an external power source via the AC/DC adapter or from a battery into a plurality of voltages required to operate the laptop PC 1. The power circuit 33 supplies power to each unit in the laptop PC 1, based on control by the embedded controller 31.

The SSD 40 is a memory drive device including a rewritable non-volatile memory, and stores an OS, various drivers, various services/utilities, application programs, and various data. The laptop PC 1 executes various information processing using data stored in the SSD 40. The SSD 40 is connected to the chipset 21 via, for example, a PCI-Express bus (hereinafter also referred to as a PCIe bus).

The SSD 40 is capable of communication not only via a PCIe bus interface (first interface), but also via a System Management Bus (SMBus) interface (second interface) through the embedded controller 31. The SSD 40 is connected to the chipset 21 via, for example, the PCI-Express bus. The SSD 40 includes a flash memory 41, a temporary memory 42, and a memory controller 43.

The flash memory 41 is an example of a non-volatile storage medium, and is, for example, a NAND flash memory. For example, the flash memory 41 includes floating gate type memory cells, charge trap type memory cells that store data by trapping electrons in a charge trap layer without including a floating gate, and the like. The temporary memory 42 is an example of a volatile storage medium, and is, for example, a static random access memory (SRAM) or a DRAM.

The memory controller 43 is, for example, a processor including a CPU, a ROM, and a RAM (not illustrated), and comprehensively controls the SSD 40. For example, the memory controller 43 executes control processing of a host interface (host I/F) between the chipset 21 and the embedded controller 31, control processing of a memory interface (memory I/F) between the flash memory 41 and the temporary memory 42, and data management processing of the flash memory 41 and the temporary memory 42.

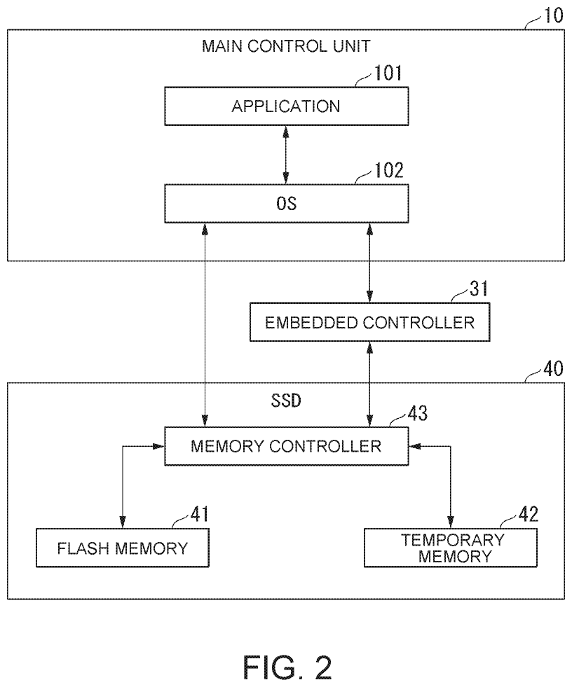

Next, the functional configuration of the laptop PC 1 according to this embodiment will be described with reference to FIG. 2. FIG. 2 is a functional block diagram illustrating an example of the functional configuration of the laptop PC 1 according to this embodiment.

As illustrated in FIG. 2, the laptop PC 1 includes the main control unit 10, the embedded controller 31, and the SSD 40.

The main control unit 10 is a functional unit implemented by the CPU 11 and the chipset 21 executing programs stored in the main memory 12, and executes various processes (information processing) based on the OS. The main control unit 10 executes, for example, various processes based on data stored in the SSD 40 and management processing for managing the SSD 40. The main control unit 10 includes an application 101 and an OS 102. The SSD 40 includes the flash memory 41, the temporary memory 42, and the memory controller 43, as mentioned above.

The application 101 executes various processes including communication with the SSD 40. The main control unit 10 may include a plurality of applications 101. The OS 102 manages the states of processes executed by the application 101 and controls the application 101.

In the case of writing data processed by the application 101 to the SSD 40 or reading data to be processed by the application 101 from the SSD 40, the OS 102 outputs, to the SSD 40, an instruction related to writing or reading of data.

The memory controller 43 writes data to the flash memory 41 or reads data from the flash memory 41 according to the instruction output from the OS 102. The memory controller 43 stores, in the temporary memory 42, logs of communication executed between the OS 102 and the memory controller 43 and cache data frequently used by the memory controller 43.

The embedded controller 31 monitors the state of the OS 102, the application 101, or the SSD 40. In the case where the OS 102 or the like hangs up, the embedded controller 31 causes the SSD 40 to execute a process of storing data stored in the temporary memory 42 into the flash memory 41.

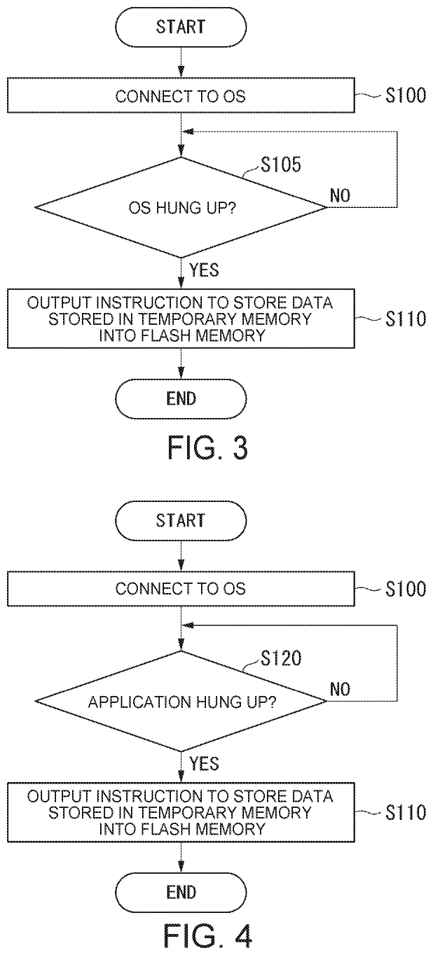

Next, the operation of the embedded controller 31 in the case where the OS 102 or the like hangs up will be described with reference to FIGS. 3 to 5. FIGS. 3 to 5 are flowcharts illustrating an example of the operation of the embedded controller 31 according to this embodiment. After the OS 102 starts communication with the SSD 40, the processes illustrated in FIGS. 3 to 5 are executed.

First, a case where the OS 102 hangs up will be described. FIG. 3 illustrates an example of the operation of the embedded controller 31 in this case.

### Step S100

The embedded controller 31 connects to the OS 102.

### Step S105

The embedded controller 31 receives a signal output from the OS 102, and determines, based on the signal, whether the OS 102 has hung up.

In the case of a Windows (registered trademark) OS as an example, while the OS 102 is operating normally, the OS 102 periodically generates a heartbeat, for example, once per second. If the heartbeat is received within a predetermined period (for example, one second) , the embedded controller 31 determines that the OS 102 has not hung up. When the OS 102 hangs up, the OS 102 stops generating the heartbeat. If no heartbeat is received within the predetermined period (for example, one second or more), the embedded controller 31 determines that the OS 102 has hung up.

When the OS 102 has not hung up, the embedded controller 31 executes step S105 again. When the OS 102 has hung up, the embedded controller 31 executes the following step S110.

### Step S110

The embedded controller 31 outputs, to the SSD 40, an instruction to store data stored in the temporary memory 42 into the flash memory 41. The memory controller 43 receives the instruction, and stores logs stored in the temporary memory 42 into the flash memory 41. The memory controller 43 may store cache data into the flash memory 41 in addition to the logs.

Even when the OS 102 has hung up, the SSD 40 is operating normally. The embedded controller 31 can thus store the data stored in the temporary memory 42 into the flash memory 41.

Next, a case where the application 101 hangs up will be described. FIG. 4 illustrates an example of the operation of the embedded controller 31 in this case. Description of the same processes as those illustrated in FIG. 3 will be omitted.

### Step S120

The embedded controller 31 receives a signal output from the OS 102, and determines, based on the signal, whether the application 101 has hung up.

For example, while the application 101 is operating normally, the application 101 periodically generates a heartbeat. In the case of a Windows (registered trademark) OS as an example, System Center Operations Manager (SCOM) monitors the heartbeat. When the heartbeat stops, SCOM outputs an alert. When no alert is received, the embedded controller 31 determines that the application 101 has not hung up. When the alert is received, the embedded controller 31 determines that the application 101 has hung up.

In the case of a Windows (registered trademark) OS, when the application 101 hangs up, Desktop Window Manager outputs a signal indicating that the application 101 has hung up. The embedded controller 31 may determine that the application 101 has not hung up when the signal is not received, and determine that the application 101 has hung up when the signal is received.

Steps S100 and S110 are the same as the respective steps illustrated in FIG. 3.

Even when the application 101 has hung up, the SSD 40 is operating normally. The embedded controller 31 can thus store the data stored in the temporary memory 42 into the flash memory 41.

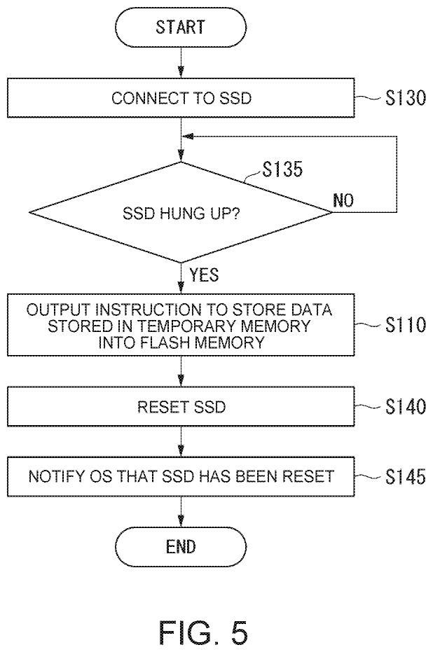

Next, a case where the SSD 40 hangs up will be described. FIG. 5 illustrates an example of the operation of the embedded controller 31 in this case. Description of the same processes as those illustrated in FIG. 3 will be omitted.

### Step S130

The embedded controller 31 connects to the SSD 40.

### Step S135

The embedded controller 31 receives a signal output from the SSD 40, and determines, based on the signal, whether the SSD 40 has hung up.

While the SSD 40 is operating normally, the SSD 40 periodically generates a heartbeat. If the heartbeat is received within a predetermined period, the embedded controller 31 determines that the SSD 40 has not hung up.

When the SSD 40 hangs up, the SSD 40 stops generating the heartbeat. If no heartbeat is received within the predetermined period, the embedded controller 31 determines that the SSD 40 has hung up.

When the SSD 40 has not hung up, the embedded controller 31 executes step S135 again. When the SSD 40 has hung up, the embedded controller 31 executes step S110. Step S110 is the same as step S110 illustrated in FIG. 3.

### Step S140

After step S110 is executed, the embedded controller 31 resets the SSD 40. Specifically, the embedded controller 31 stops power supply to the SSD 40 and restarts power supply to the SSD 40.

### Step S145

The embedded controller 31 notifies the OS 102 that the SSD 40 has been reset. The OS 102 can resume communication with the SSD 40 without resetting the SSD 40.

Even when the SSD 40 has hung up, part of the functions of the SSD 40 may still be operating. If the memory controller 43 is capable of controlling the flash memory 41 and the temporary memory 42, the embedded controller 31 can store the data stored in the temporary memory 42 into the flash memory 41.

Although an example in which the present invention is applied to the SSD 40 has been described in this embodiment, the present invention is not limited to such. The present invention may be applied to storage such as a hard disk drive (HDD) or a USB flash drive.

As described above, the laptop PC 1 (information processing apparatus) is connectable to the SSD 40 (storage) and includes the embedded controller 31 (controller). When an abnormality is detected after the OS 102 starts communication with the SSD 40, the embedded controller 31 outputs, to the SSD 40, an instruction to store data stored in the temporary memory 42 (volatile memory) into the flash memory 41 (non-volatile memory). With this configuration, the laptop PC 1 can save data stored in the temporary memory 42 in the SSD 40. Even after the SSD 40 is reset, the data stored in the flash memory 41 is available.

The embedded controller 31 outputs the foregoing instruction to the SSD 40 when an abnormality of the OS 102 is detected. Thus, when an abnormality such as a hang-up of the OS 102 occurs, the laptop PC 1 can save data stored in the temporary memory 42 in the SSD 40.

The embedded controller 31 receives a heartbeat output by the OS 102 while the OS 102 is operating normally. When the OS 102 stops outputting the heartbeat, the embedded controller 31 outputs the foregoing instruction to the SSD 40. Thus, the laptop PC 1 can detect an abnormality such as a hang-up of the OS 102 by monitoring the heartbeat output by the OS 102.

The embedded controller 31 outputs the foregoing instruction to the SSD 40, upon receiving an abnormality signal output when the OS 102 detects an abnormality of the application 101 of the laptop PC 1. Thus, when an abnormality such as a hang-up of the application 101 occurs, the laptop PC 1 can save data stored in the temporary memory 42 in the SSD 40.

The embedded controller 31 outputs the foregoing instruction to the SSD 40 when an abnormality of the SSD 40 is detected. £ Thus, when an abnormality such as a hang-up of the SSD 40 occurs, the laptop PC 1 can save data stored in the temporary memory 42 in the SSD 40.

The embedded controller 31 resets the SSD 40 after outputting the foregoing instruction to the SSD 40. Thus, when an abnormality such as a hang-up of the SSD 40 occurs, the laptop PC 1 can restore the SSD 40 to a normal state.

The embedded controller 31 receives a heartbeat output by the SSD 40 while the SSD 40 is operating normally. When the SSD 40 stops outputting the heartbeat, the embedded controller 31 outputs the foregoing instruction to the SSD 40. Thus, the laptop PC 1 can detect an abnormality such as a hang-up of the SSD 40 by monitoring the heartbeat output by the SSD 40.

### Second Embodiment

Typically, repeated overwriting of data in a non-volatile memory causes the non-volatile memory to deteriorate, and accordingly the number of times data can be written to the non-volatile memory is limited. Therefore, a volatile memory is used to temporarily store data that is frequently generated or updated. On the other hand, it is also possible to use a non-volatile memory that is less likely to deteriorate even when data is repeatedly overwritten. In a second embodiment, the flash memory 41 is used instead of the temporary memory 42 as a memory for temporarily storing data. In the second embodiment, the temporary memory 42 is not essential.

When no hang-up of the OS 102 or the like has occurred, the embedded controller 31 causes the SSD 40 to execute a process of storing, in the flash memory 41, data related to communication between the OS 102 and the SSD 40. When the OS 102 or the like has hung up, the embedded controller 31 causes the SSD 40 to execute a process of prohibiting overwriting of data in the flash memory 41. As a result of prohibiting overwriting of data in the flash memory 41, data already stored in the flash memory 41 is not erased.

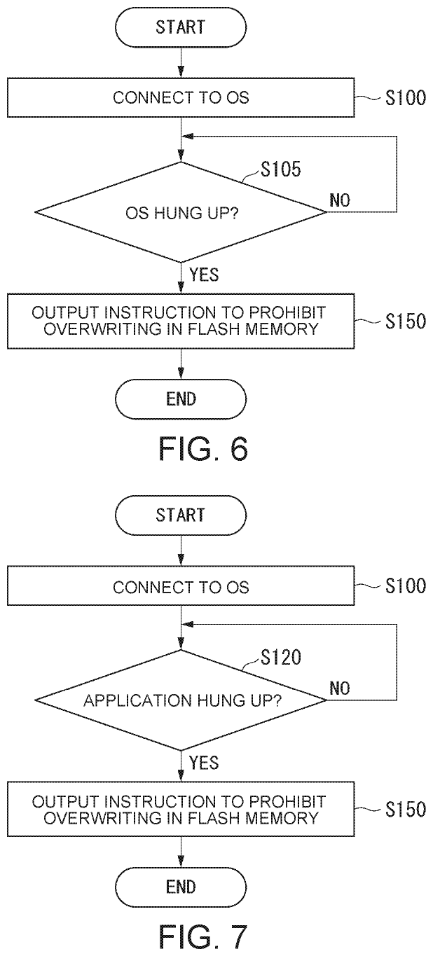

The operation of the embedded controller 31 in the case where the OS 102 or the like hangs up will be described with reference to FIGS. 6 to 8. FIGS. 6 to 8 are flowcharts illustrating an example of the operation of the embedded controller 31 according to this embodiment. After the OS 102 starts communication with the SSD 40, the processes illustrated in FIGS. 6 to 8 are executed.

Immediately after each of the processes illustrated in FIGS. 6 to 8 is started, writing of data to the flash memory 41 is set to be enabled. Therefore, logs and cache data are stored into the flash memory 41.

FIG. 6 illustrates an example of the operation of the embedded controller 31 in the case where the OS 102 hangs up. The embedded controller 31 executes the following step S150 instead of step S110 illustrated in FIG. 3. In other respects, the process illustrated in FIG. 6 is the same as the process illustrated in FIG. 3.

### Step S150

When the OS 102 has hung up, the embedded controller 31 outputs, to the SSD 40, an instruction to prohibit overwriting of data in the flash memory 41. The memory controller 43 receives the instruction, and performs setting to prohibit overwriting of data in the flash memory 41.

FIG. 7 illustrates an example of the operation of the embedded controller 31 in the case where the application 101 hangs up. The embedded controller 31 executes step S150 instead of step S110 illustrated in FIG. 4. Step S150 illustrated in FIG. 7 is the same as step S150 illustrated in FIG. 6. In other respects, the process illustrated in FIG. 7 is the same as the process illustrated in FIG. 4.

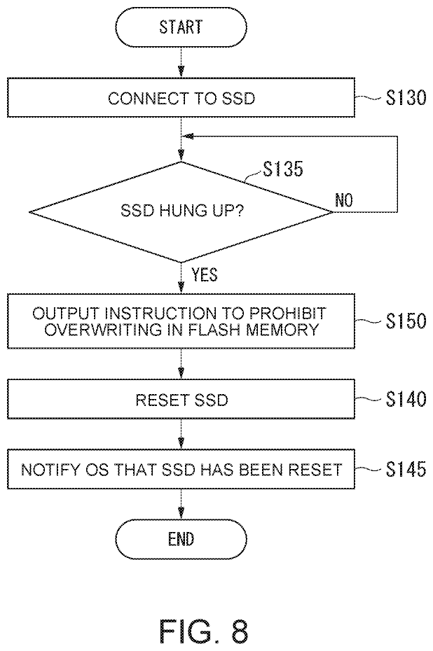

FIG. 8 illustrates an example of the operation of the embedded controller 31 in the case where the SSD 40 hangs up. The embedded controller 31 executes step S150 instead of step S110 illustrated in FIG. 5. Step S150 illustrated in FIG. 8 is the same as step S150 illustrated in FIG. 6. In other respects, the process illustrated in FIG. 8 is the same as the process illustrated in FIG. 5.

As described above, the laptop PC 1 (information processing apparatus) is connectable to the SSD 40 (storage) and includes the embedded controller 31 (controller). When an abnormality is detected after the OS 102 starts communication with the SSD 40 and storing of data in the flash memory 41 (non-volatile memory) is started, the embedded controller 31 outputs, to the SSD 40, an instruction to prohibit overwriting of data in the flash memory 41. With this configuration, the laptop PC 1 can save data stored in the flash memory 41 in the SSD 40. Even after the SSD 40 is reset, the data stored in the flash memory 41 is available.

Although embodiments of the present invention have been described in detail above with reference to the drawings, the specific configuration is not limited to the embodiments described above, and design changes and the like are also included within the scope that does not deviate from the gist of the present invention.

### DESCRIPTION OF SYMBOLS

1 laptop PC
10 main control unit
11 CPU
12 main memory
13 video subsystem
14 display unit
21 chipset
22 BIOS memory
31 embedded controller
32 input unit
33 power circuit
40 SSD
41 flash memory
42 temporary memory
43 memory controller

What is claimed is:

1. An information processing apparatus connectable to a storage device, the information processing apparatus comprising
a controller configured to output, to the storage device, an instruction to store data stored in a volatile memory of the storage device into a non-volatile memory of the storage device, when an abnormality is detected after an operating system (OS) of the information processing apparatus starts communication with the storage device.

2. An information processing apparatus connectable to a storage device, the information processing apparatus comprising
a controller configured to output, to the storage device, an instruction to prohibit overwriting of data in a non-volatile memory of the storage device, when an abnormality is detected after an operating system (OS) of the information processing apparatus starts communication with the storage device and storing of the data in the non-volatile memory is started.

3. The information processing apparatus according to claim 1, wherein the controller is configured to output the instruction to the storage device when an abnormality of the OS is detected.

4. The information processing apparatus according to claim 3, wherein the controller is configured to
receive a heartbeat output by the OS while the OS is operating normally, and
output the instruction to the storage device when the OS stops outputting the heartbeat.

5. The information processing apparatus according to claim 1, wherein the controller is configured to output the instruction to the storage device upon receiving an abnormality signal output when the OS detects an abnormality of an application of the information processing apparatus.

6. The information processing apparatus according to claim 1, wherein the controller is configured to output the instruction to the storage device when an abnormality of the storage device is detected.

7. The information processing apparatus according to claim 6, wherein the controller is configured to
receive a heartbeat output by the storage device while the storage device is operating normally, and
output the instruction to the storage device when the storage device stops outputting the heartbeat.

8. The information processing apparatus according to claim 6, wherein the controller is configured to reset the storage device after outputting the instruction to the storage device.

9. A control method for an information processing apparatus connectable to a storage device, the control method comprising
outputting, to the storage device, an instruction to store data stored in a volatile memory of the storage device into a non-volatile memory of the storage device, when an abnormality is detected after an operating system (OS) of the information processing apparatus starts communication with the storage device.

10. The information processing apparatus according to claim 2, wherein the controller is configured to output the instruction to the storage device when an abnormality of the OS is detected.

11. The information processing apparatus according to claim 10, wherein the controller is configured to
receive a heartbeat output by the OS while the OS is operating normally, and
output the instruction to the storage device when the OS stops outputting the heartbeat.

12. The information processing apparatus according to claim 2, wherein the controller is configured to output the instruction to the storage device upon receiving an abnormality signal output when the OS detects an abnormality of an application of the information processing apparatus.

13. The information processing apparatus according to claim 2, wherein the controller is configured to output the instruction to the storage device when an abnormality of the storage device is detected.

14. The information processing apparatus according to claim 13, wherein the controller is configured to
receive a heartbeat output by the storage device while the storage device is operating normally, and
output the instruction to the storage device when the storage device stops outputting the heartbeat.

15. The information processing apparatus according to claim 13, wherein the controller is configured to reset the storage device after outputting the instruction to the storage device.
